(19) United States
(12) Patent Application Publication
(10) Pub. No.: US 2009/0240746 A1
(43) Pub. Date: Sep. 24, 2009

(54) Method and system for creating a virtual customized dataset

(75) Inventors: Peter J. Chirlian, Basking Ridge, NJ (US); Bei Gu, Montgomery Township, NJ (US); Eric J. Kaplan, Allendale, NJ (US); Aleksandr Shukhat, Milburn, NJ (US)

Correspondence Address: STERNE, KESSLER, GOLDSTEIN & FOX P.L.L.C., 1100 NEW YORK AVENUE, N.W., WASHINGTON, DC, 20005, US

(73) Assignee: ARMANTA, INC., Morristown, NJ (US)

(21) Appl. No.: 12/076,427

(22) Filed: Mar. 18, 2008

(51) Int. Cl. G06F 12/16; G06F 17/30

(52) U.S. Cl. 707/204; 711/E12.103; 707/E17.044

(57) ABSTRACT

A method and a system for creating a virtual customized dataset. A choice of one or more source datasets is first received. A filter definition for each source dataset is also received. Such a filter definition can be embodied in one or more rules. The rules are then applied to the respective source datasets to create one or more filtered source datasets. Filtered source datasets are then copied to create copied source datasets. A scaling factor is then computed for each copied source dataset. The scaling factors are then applied to the respective copied source datasets, which creates respective scaled source datasets. The scaled source datasets are then merged to create a single virtual customized dataset. This virtual customized dataset can then be output to memory, and/or presented to a user for analysis purposes. The process can be reiterated by a user, varying any of several variables, such as the choice of source datasets, the filter definitions, and scaling factors.

### BACKGROUND OF THE INVENTION

1. Field of the Invention

The invention described herein relates to data processing, and in particular relates to the creation of customized datasets.

2. Background Art

Investigators and analysts in virtually any numerically-based field of study often need to analyze information that is organized as a large dataset. A dataset, as the term is used in this application, can refer to any structured body of information. Examples might include, for example, a set of statistical samples, an historical record of numerical data, or a table or database of experimental results. A more concrete example would be a financial spreadsheet representing a portfolio of investments, or some other structured collection of financial data. Moreover, analysts sometimes require that one or more hypothetical datasets be created. Such a hypothetical, or virtual, dataset allows the analysis of hypothetical situations and hypothetical bodies of data. This permits the evaluation of possible solutions to problems, for example, and the forecasting of results based on a hypothetical starting point.

In the field of investment analysis, a virtual dataset may be a benchmark portfolio, i.e., a hypothetical set of positions in particular investments having a known value at a given point in time. The performance of such a benchmark portfolio will be measurable over time. This portfolio and its performance can then be used as a standard against which to measure the performance of other portfolios, whether real or hypothetical. Such a portfolio may be a function or mixture of other portfolios having known positions, characteristics, and histories. Moreover, the specific portfolios used as inputs to the creation of the benchmark portfolio and the rules used to combine them may be user-defined. A virtual portfolio can therefore be customized.

Using conventional technology, a construction of such a virtual customized portfolio from known portfolios is tedious and time consuming. The construction of such a portfolio requires the development and implementation of rules that govern the construction. Such rules need to describe what portfolios may be combined, what proportions of these portfolios must be used, and what holdings to keep or discard. Assuming a programmable computing environment, the implementation of such rules requires new coding for any new rule. If an analyst decides to revise a rule or implement a new rule, new code must be written to create the new rule. For this reason, current technology does not allow revision of a virtual portfolio without new coding. Current approaches are therefore slow and do not allow spontaneous changes to a virtual portfolio. This constrains the analysis that can be performed, because manipulations must effectively be re-coded each time a revision is desired.

What is needed, therefore, is a system and method by which a dataset, such as a one representing an investment portfolio, can be customized, such that customization can happen quickly, and easily, without having the need for re-coding every time the dataset needs to be manipulated.

### BRIEF DESCRIPTION OF THE DRAWINGS/FIGURES

FIG. 1 is a flowchart illustrating the overall processing of the invention, according to an embodiment thereof.

FIG. 2 is a data flow diagram illustrating the invention in terms of inputs, intermediate results, and processes, according to an embodiment of the invention.

FIG. 3 is a data flow diagram illustrating the steps of copying, scaling, and merging, according to an embodiment of the invention.

FIG. 4 is a block diagram illustrating an entity model, as may be used in an embodiment of the invention.

FIG. 5 illustrates how an entity model can be used to support the processing of the invention, according to an embodiment thereof.

FIG. 6 illustrates the hierarchical structure of an entity model, according to an embodiment of the invention.

FIG. 7 illustrates the merging of various holdings from various portfolios, according to an embodiment of the invention.

FIG. 8 illustrates a possible system context in which an embodiment of the invention may operate.

Further embodiments, features, and advantages of the present invention, as well as the operation of the various embodiments of the present invention, are described below with reference to the accompanying drawings.

### DETAILED DESCRIPTION OF THE INVENTION

A preferred embodiment of the present invention is now described with reference to the figures, where like reference numbers indicate identical or functionally similar elements. Also in the figures, the leftmost digit of each reference number corresponds to the figure in which the reference number is first used. While specific configurations and arrangements are discussed, it should be understood that this is done for illustrative purposes only. A person skilled in the relevant art will recognize that other configurations and arrangements can be used without departing from the spirit and scope of the invention. It will be apparent to a person skilled in the relevant art that this invention can also be employed in a variety of other systems and applications.

The invention described herein represents a method and a system for creating a virtual customized dataset. A choice of one or more source datasets is first received. A filter definition for each source dataset is also received. Such a filter definition can be embodied in one or more rules. The rules are then applied to the respective source datasets to create one or more filtered source datasets. Filtered source datasets are then copied to create copied source datasets. A scaling factor is then computed for each copied source dataset. The scaling factors are then applied to the respective copied source datasets, which creates respective scaled source datasets. The scaled source datasets are then merged to create a single virtual customized dataset. This virtual customized dataset can then be output to memory, and/or presented to a user for analysis purposes. The process can be reiterated by a user, varying any of several variables, such as the choice of source datasets, the filter definitions, and scaling factors.

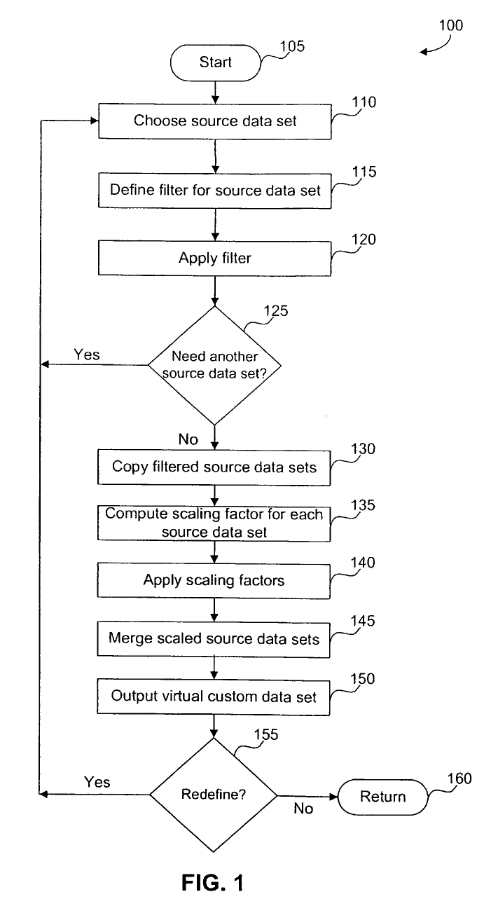

The overall processing of the invention is illustrated in FIG. 1, according to an embodiment thereof. The process begins at step 105. In step 110, at least one source dataset is chosen. In the context of creating a virtual customized investment portfolio (e.g., a benchmark), a source dataset may represent a preexisting portfolio. Such a source dataset may itself be virtual or may be real. Moreover, the choice can be made by a user.

In step 115, a filter for the source dataset is defined. In an embodiment of the invention, such a filter specifies what elements of the source dataset are to be included in the resulting virtual customized dataset. In the context of creating a customized virtual investment portfolio, such a filter may, for example, define specific holdings to be included. In alternative embodiments, a filter may define specific classes of holdings to be included. In step 120, the filter is applied to the chosen source dataset. The result is a filtered source dataset.

In step 125, a determination is made as to whether another source dataset is needed. If so, the processor returns to step 110, in which a subsequent source dataset is chosen. Steps 115 and 120 can then be repeated for another source dataset. The same or different filters may be defined and applied.

If no additional source dataset is needed in step 125, the process continues to step 130. Here, the filtered source datasets are copied. This allows for subsequent manipulation of copies of the filtered source datasets, rather than manipulation of the actual filtered source datasets. In step 135, a scaling factor is computed for each source dataset. A scaling factor can be viewed as a normalization factor. A scaling factor is used to scale a given filtered source dataset to allow creation of a final virtual customized dataset that includes a specified proportion of the initial source datasets. In step 140, the scaling factors are applied to the respective filtered source datasets. In an embodiment of the invention, the scaling factor for a copied source dataset x is

$${scaleFactor}_{x} = \frac{{wgt}_{x}}{{MV}_{x}} * {\sum }_{i = 0}^{n} {MV}_{i}$$

where wgtₓ is a weight for source dataset x and MVᵢ is the market value of the source data set i.

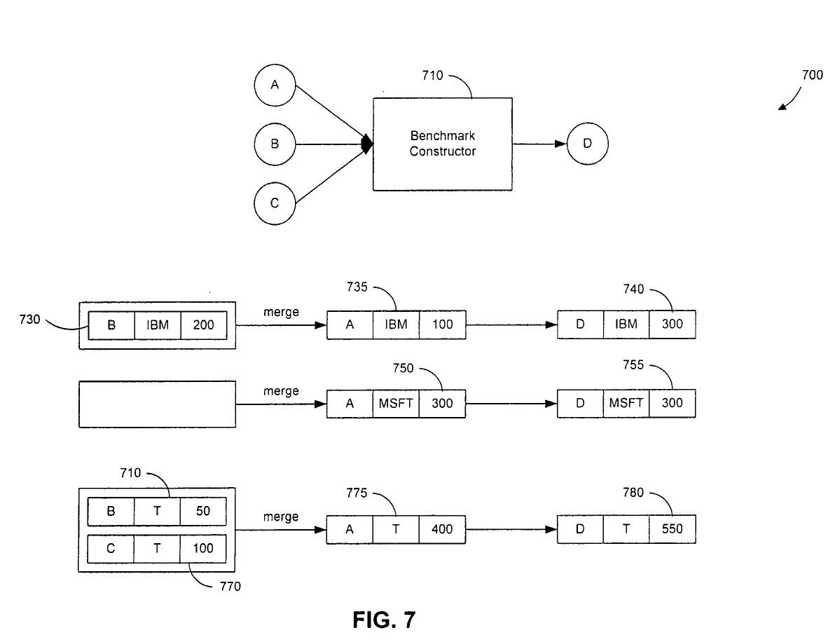

In step 145, the scaled source datasets are merged. This allows, for example, the aggregation of like holdings from the various source datasets into a single holding. In the context of financial portfolios, for example, a given portfolio might have some number of shares of a given stock, while another dataset may have another quantity of the same stock. In step 145, such like holdings are combined into a single set of shares for the given stock. The merge process will be described in greater detail below with respect to FIG. 7.

Note that the steps of defining and applying filters, copying filtered source datasets, and computing and applying scaling factors may be collectively performed in serial for successive chosen source datasets. Alternatively, these steps may be collectively performed in parallel across multiple chosen source datasets.

In step 150, a virtual custom dataset is output, representing the result of the merging process of step 145. In step 155, a determination is made as to whether the virtual custom dataset needs to be redefined or if an additional virtual custom dataset needs to be created. If so, the process returns to step 110. This option may be chosen, for example, if the analyst chooses to vary the source datasets used, or if the analyst would like to revise filter definitions, for example. Otherwise, the process concludes at step 160.

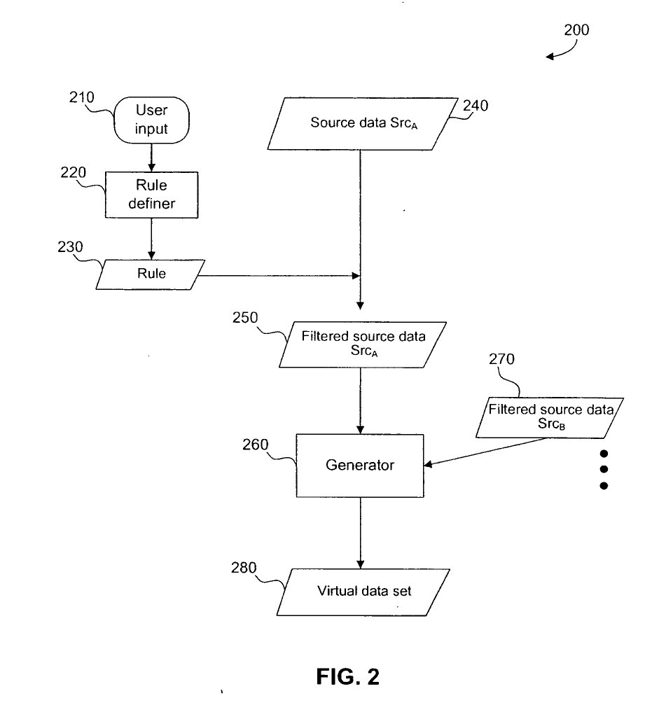

FIG. 2 is a dataflow diagram illustrating the processing of an embodiment of the invention. A user provides an input 210 to a rule definer module 220. This results in a rule 230. The input 210 and the rule 230 represent a filter that is applied to source dataset 240. While a single rule or filter 230 is illustrated, in alternative implementations of the invention, a plurality of rules may be defined and applied.

Applying the rule 230 to the source dataset 240, results in a filtered source dataset 250. Filtered source dataset 250 is then input to a generator 260. In the illustrated embodiment, generator 260 embodies the copying of the source dataset, the computation and application of a scaling factor, and the merging of a scaled source dataset with other scaled source datasets. Note also, that additional filtered source datasets may also be input to generator 260. A second filtered source dataset 270 is illustrated, as an additional input to generator 260. As discussed above, a virtual customized dataset, such as dataset 280, can be a function of multiple filtered source datasets.

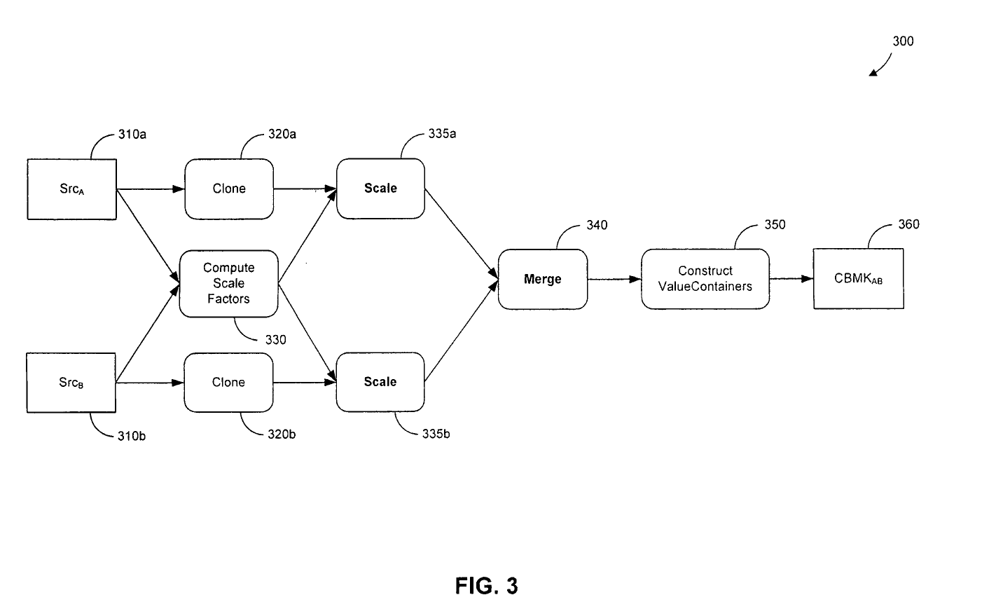

FIG. 3 illustrates another perspective on the processing of the invention. This figure illustrates the manipulation of multiple source datasets to result in a single virtual customized dataset. The process begins with two or more source datasets. These are illustrated in FIG. 3 as datasets 310a, and 310b. Source dataset 310a is input to a copying process, illustrated as a “cloning” process 320a. Likewise, source dataset 310b is input to a cloning process 320b. A scaling factor is computed at step 330 for each of source datasets 310a and 310b. The scaling factor associated with source dataset 310a is applied to a copy of that dataset. This scaling is performed at step 335a. Likewise, the scaling factor associated with source dataset 310b is applied to a copy of source dataset 310b. This is done in scaling step 335b. This results in two scaled source datasets, which are merged in step 340. The result is a single virtual customized dataset. In an embodiment of the invention, this virtual customized dataset is stored, in step 350, in a set of value containers according to an entity model. An entity model that can be used with this invention will be discussed in greater detail below. The result is output 360.

Note that while FIG. 3 illustrates the construction of a virtual customized dataset from two source datasets, alternative embodiments of the invention can use more than two source datasets as inputs.

In an embodiment of the invention, datasets can be implemented using an entity model. An entity model can be viewed as a high level, coarse grained inventory of entities and their relationships. One or more entities can be organized as a cache of information. Caches and entities can be related to one another through primary and foreign keys. The system of primary and foreign keys may be similar to that typically used in a relational database.

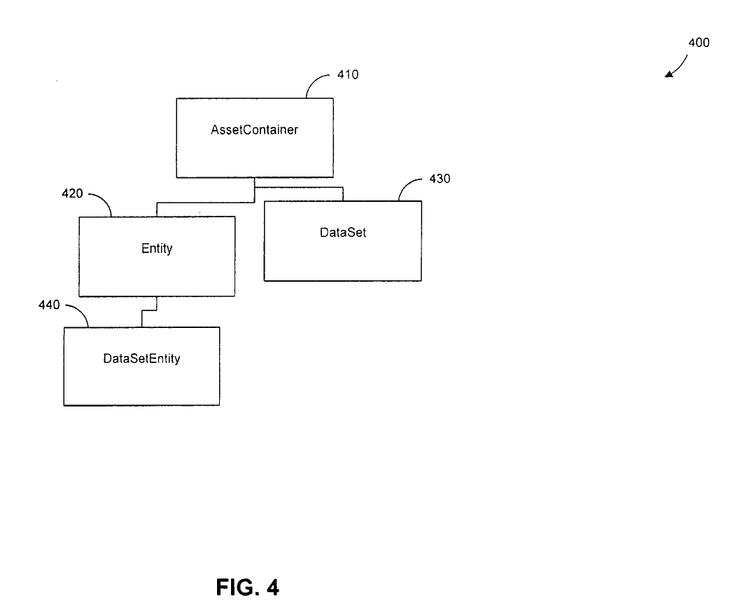

A generic entity model is illustrated in FIG. 4. Here, an entity model 410 is labeled as an asset container. Subordinate to asset container 410 are two child elements, entity 420 and dataset 430. In the context of storing and processing investment portfolios, dataset 430 can correspond to a portfolio. Entity 420 can then correspond to a particular holding in the portfolio of dataset 430. Subordinate to entity 420 are one or more dataset entities 440.

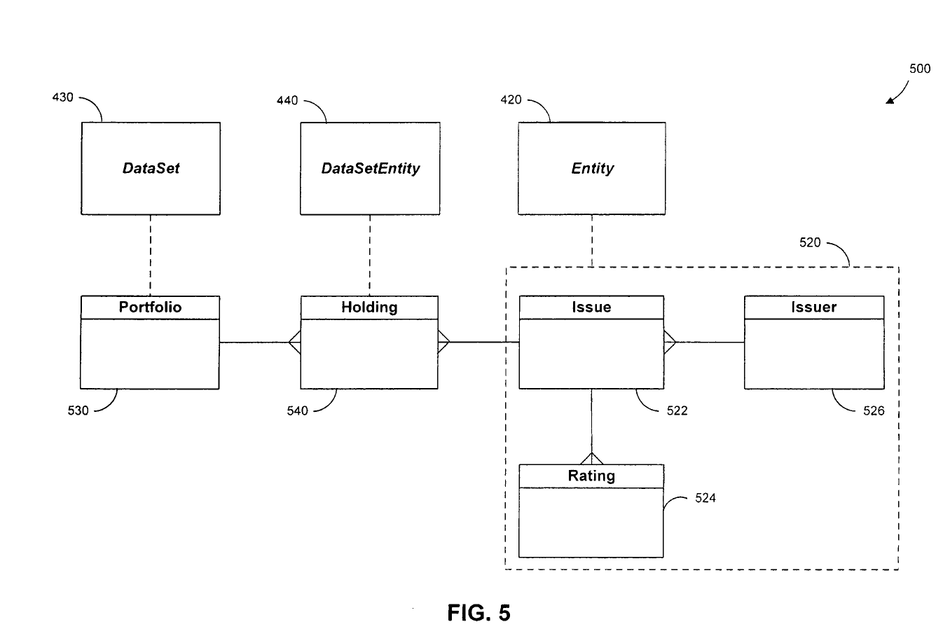

FIG. 5 illustrates a more particular example of how an entity model can be used to represent financial portfolios as datasets. As noted above, dataset 430 corresponds to a portfolio 530. The portfolio 530 includes one or more holdings 540. Data related to holding 540 is contained in an entity 520. Entity 520 corresponds to entity 420 from the more abstract depiction of FIG. 4. Specific information within entity 520 may include, for example, the identity of the issue 522, the rating 524 of the issue 522, and the related issuer 526.

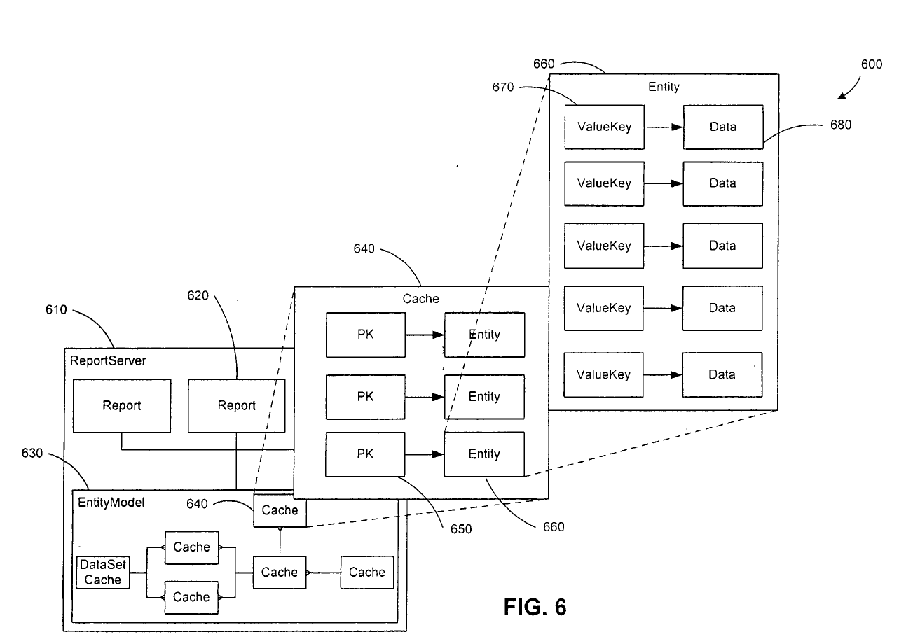

A given entity model may include a plurality of caches, each of which may include a plurality of entities. Any given entity may include a plurality of data items. This is illustrated in FIG. 6. This is an exploded view of an entity model 630, which may be part of a larger report server object 610. As will be described below, entity model 630 includes the information required to populate a report 620.

Entity model 630 includes one or more caches, such as cache 640. As noted above, a cache 640 may correspond to a portfolio. Cache 640 includes one or more entities, such as entity 660. Each entity is identified by a primary key. The primary key for entity 660 is key 650. If cache 640 represents a portfolio, then entity 660 may represent a particular holding in the portfolio.

Entity 660 may include one or more data items 680. A given data item 680 is associated in this illustration with a value key 670. A particular data item may be, for example, a market value, a number of shares, or a rating for the holding.

Note that the organization of information in an entity model (as shown in this figure, for example) permits manipulation of the information, e.g., scaling, filtering, and merging, and further allows these processes to take place in a manner that allows related dependent values to change as a consequence.

FIG. 7 illustrates the processing of the invention using the entity model described above. The illustrated embodiment includes a benchmark constructor 710, which embodies all of the processing performed in FIG. 1. Three portfolios, or datasets (labeled A, B, and C), are inputs to benchmark constructor 710. The output is a virtual customized dataset, or portfolio, labeled D.

The operation of benchmark constructor 710 includes the merge process. Three examples of this process are also illustrated in FIG. 7. In the first example, a particular entity 730 takes part in the merge process. This entity is from portfolio B, and represents 200 shares of IBM. Entity 730 is merged with another entity 735. Entity 735 represents a holding of 100 shares of IBM stock, from portfolio A. The result of the merge process is shown as entity 740. The two previous holdings are combined to form a single entity that represents a position of 300 shares of IBM stock, in portfolio D, the resulting virtual customized dataset.

In the next example, 300 shares of Microsoft stock are held in portfolio A, as indicated in entity 750. Here, no other portfolio includes any shares of Microsoft. Any merge process that is applied, therefore, results in a simple movement of the 300 shares of Microsoft into portfolio D. This is indicated in entity 755.

In the third example, portfolio B includes 50 shares of a stock T, as indicated in entity 765. Portfolio C includes 100 shares of the same stock, as indicated in entity 770. These two holding are then merged with 400 shares of stock T that are held in portfolio a. This latter holding is indicated as entity 775. The merger process results in a single holding in portfolio D, shown as 550 shares of this stock.

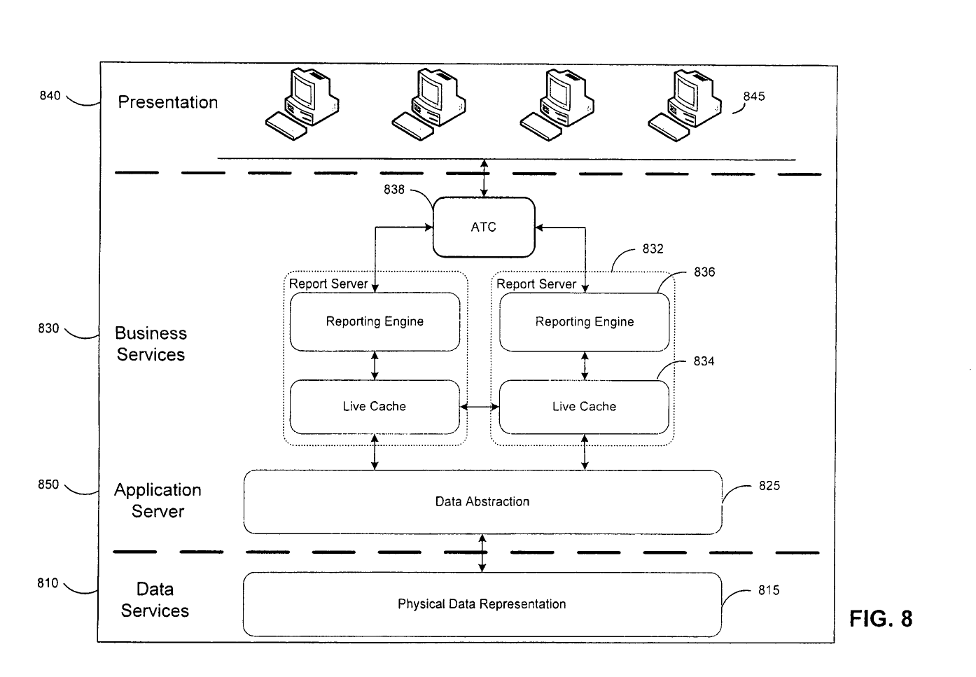

Once a virtual customized dataset is created, it can be stored in random access memory and/or into a database, just as any other dataset can be stored. Likewise, the virtual customized dataset can be output and viewed, just as any other source dataset can be viewed. This is illustrated in FIG. 8, according to an embodiment of the invention. At a data services layer 810, information corresponding to the datasets is stored in a physical data representation 815. At an application server level 820, the data of physical data representation 815 is abstracted. This is shown as data abstraction 825. Data abstraction 825 maps information that resides in data representation 815, whether in the form of databases, flat files, or live data sources. Data abstraction 825 therefore includes file parsing capabilities, and may also include logging and audit capability.

At a business services layer 830, a cache, such as cache 834 can be read into a reporting engine 836. The reporting engine 836 and cache 834 may be embodied in a report server 832. As described above, cache 834 can represent data as one or more data models. Moreover, information stored in a cache can be manipulated and used to generate additional data (such as virtual customized datasets). If a particular value is changed, the structure of the entity model further allows dependent values to change.

A report generated by report server 832 can then be sent to presentation layer 840, for viewing at a workstation, such as workstation 845. Demand for reports at the workstations is mediated by module 838. This module is metaphorically labeled as an “air traffic controller” (ATC).

The processing of the invention can be implemented in a variety of embodiments. In particular, the processing of rule definer 220, generator 260, and constructor 710 can be performed using logic that takes the form of hardware, software, or firmware, or any combination thereof. Logic embodied as software may be stored in any memory medium known to persons of skill in the art, such as read only memory, optical disks, flash memory, etc. Such logic would take the form of instructions and data, whereby the instructions would be executed by a programmable processor in communication with the memory medium. The processor may be any commercially available device or may be a custom device.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method of creating a virtual customized dataset, comprising:
a) receiving a choice of one or more source datasets;
b) receiving one or more rules that comprise a filter definition for each source data set;
c) applying filters defined by the respective definitions to the respective source datasets to create one or more filtered source datasets;
d) copying the filtered source datasets to create copied source datasets;
e) computing a scaling factor for each copied source dataset;
f) applying the scaling factors to the respective copied source datasets, to create scaled source datasets;
g) merging the scaled source datasets to create a single virtual customized data set; and
h) outputting the virtual customized dataset.

2. The method of claim 1, wherein said step c) comprises allowing only items specified by the respective definitions in the respective filtered source datasets.

3. The method of claim 1, wherein said step e) comprises calculating the scaling factor for a copied source dataset x as
$${scaleFactor}_{x} = \frac{{wgt}_{x}}{{MV}_{x}} * {\sum }_{i = 0}^{n} {MV}_{i}$$

4. The method of claim 1, wherein said step g) comprises:
i) searching for like items across the scaled source datasets; and
ii) combining any like items into a single combined item.

5. The method of claim 1, wherein said h) comprises saving the virtual customized dataset into a user database.

6. The method of claim 1, wherein said step h) comprises saving the virtual customized dataset in random access memory.

7. The method of claim 1, wherein said step h) comprises saving the virtual customized dataset as a new source dataset.

8. The method of claim 1, wherein said steps of claim 1 are repeated, with variation in at least one of:
chosen source datasets;
at least one filter definition; and
at least one scaling factor computation.

9. The method of claim 1, wherein said sequence of steps c) through f) is performed for each source dataset in serial.

10. The method of claim 1, wherein said sequence of steps c) through f) is performed for each source dataset in parallel.

11. The method of claim 1, wherein the source datasets comprise investment portfolios, each item comprises a position in a particular investment, and the virtual customized dataset comprises a virtual custom benchmark portfolio.

12. A system for creating a virtual customized dataset, comprising:
a rule definer module configured to receive user input and to output a rule, based on said user input, to be applied to a source dataset to create a filtered source data set; and
a generator module configured to create the virtual customized dataset from one or more filtered source datasets, said generator module comprising:
a processor; and
a memory in communication with said processor, said memory for storing a plurality of processing instructions for directing said processor to:
a) copy the filtered source datasets to create copied source data sets;
b) compute a scaling factor for each copied source dataset;
c) apply the scaling factors to the respective copied source data sets, to create scaled source datasets;
d) merge the scaled source datasets to create a single virtual customized dataset; and
e) output the virtual customized dataset.

13. The system of claim 12, wherein said source dataset comprises an investment portfolio and said virtual customized dataset comprises a virtual customized benchmark portfolio.

14. The system of claim 12, wherein processing instructions relating to step b) are configured to cause said processor to calculate the scaling factor for a copied source dataset x as
$${scaleFactor}_{x} = \frac{{wgt}_{x}}{{MV}_{x}} * {\sum }_{i = 0}^{n} {MV}_{i}$$

15. The system of claim 12, wherein processing instructions relating to said step g) are configured to cause said processor to:
i) search for like items across the scaled source datasets; and
ii) combine any like items into a single combined item.

16. The system of claim 12, further comprising storage for said source dataset, said storage configured to store said source dataset as a plurality of caches in an entity model.

17. The system of claim 12, further comprising storage for said virtual customized dataset, said storage configured to store said virtual customized dataset as a plurality of caches in an entity model.
